(19) United States
(12) Patent Application Publication
(10) Pub. No.: US 2007/0026800 A1
(43) Pub. Date: Feb. 1, 2007

(54) System and method for switching among available media source for content displayed by a projector

(75) Inventor: Shou-Kuo Hsu, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/344,260

(22) Filed: Jan. 30, 2006

(30) Foreign Application Priority Data
Jul. 29, 2005 (CN) 200510036277.0

(51) Int. Cl. H04B 7/00

(52) U.S. Cl. 455/41.2

(57) ABSTRACT

A system for switching among available media sources for content displayed by a projector includes a projector, a connecting device, and a plurality of computers. The projector is able to display content from each of the computers. Each computer is enabled for wireless communication. The contents of each computer may be wirelessly transmitted to the projector via the connecting device. An input end of the connecting device receives wireless signals of the computers. An output end of the connecting device connects with an input end of the projector. A related method for switching among available media sources for content displayed by a projector is also provided.

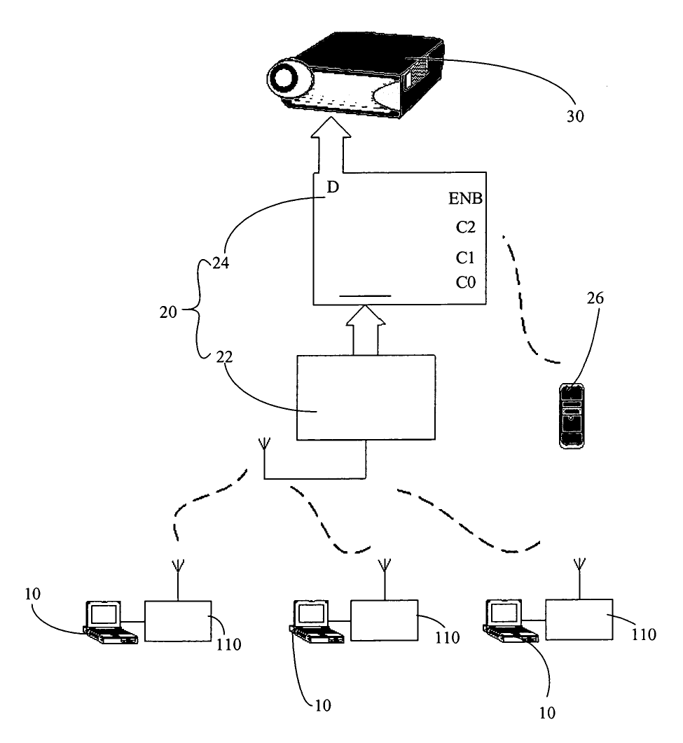

### BACKGROUND OF THE INVENTION

1. Field of the Invention

The present invention relates to a system and method for switching among sources for content displayed by a projector, and more particularly to a wireless system and method for switching among the available sources for content displayed by a projector by using wireless technology.

2. General Background

With the rapid development of wireless technology, short distance wireless communications have become more and more important. Personal Area Networks (PANs) can provide wireless connections to satisfy the needs of consumers at most any moment and nearly everywhere, and it is a convenient bridge for short distance communications.

Bluetooth technology whose development started at the beginning of the year 1998 is developed by Bluetooth Special Interest Group (BSIG), and is a low-power radio technology. It can replace cable typically used in connecting most portable devices such as personal digital assistants (PDAs), cellular phones, personal computers (PCs), printers and etc. to each other, thus clearing space of the clutter of complex line connections.

Bluetooth is a wireless PAN technology supporting wireless voice and data communication between different devices that are typically within ten meters of one another. A number of different devices can be Bluetooth-enabled, for example, cell phones, PDAs, or laptop computers. Each such device is equipped with Bluetooth components, including a receiver and a transmitter, allowing it to communicate with other similarly equipped devices nearby without the use of cables or other physical connections.

Bluetooth operates in the unlicensed Industrial, Scientific, and Medical (ISM) radio band of 2.4 GHZ. Bluetooth technology includes a number of protocols that allow Bluetooth enabled devices to operate in a Peer-to-Peer environment forming piconets. The Bluetooth protocols and specifications may be found in: Bluetooth system; Specification Volumes 1 and 2, Corn and Profiles; Version 1.1, Feb. 22nd, 2001.

At conferences, exhibitions, and the like, digital projectors are commonly used. Content shown by the projectors are usually stored in individual computers. Typically, computers and a certain projector are interconnected via cables or wires. These communication paths allow for the exchange of data or control information between such devices. However, it is increasingly recognized that certain advantages arise from the elimination of cables and wires to interconnect devices. Such advantages include ease of configuration and reconfiguration, due to the elimination of the need to physically add, remove, or displace a physical medium. Furthermore, space that would ordinarily be used for device interconnection may be cleared. Significantly, device mobility is increased through the use of wireless connections. Bluetooth is one such wireless technology used to provide convenient wireless connections.

What is needed however, to further enhance the functionality of wireless systems is a wireless system for switching among various available media sources for content displayed by a projector.

### SUMMARY

A system for switching among available media sources for content displayed by a projector in accordance with a preferred embodiment includes a projector, and a plurality of computers. The projector is able to display content from each of the computers. Each of the computers is enabled for wireless communication. The system further includes a connecting device. The contents of each computer may be wirelessly transmitted to the projector via the connecting device. The connecting device includes wireless receiving means and a multiplexer. An input end of the connecting device receives wireless signals of the computers. An output end of the connecting device connects with an input end of the projector. The multiplexer is controlled by an infrared remote controller to choose one of the computers. The contents of the chosen computer are displayed on a screen by the projector. A related method for switching among sources for content displayed by the projector is also provided.

Other advantages and novel features will become more apparent from the following detailed description when taken in conjunction with the accompanying drawing, in which:

### BRIEF DESCRIPTION OF THE DRAWINGS

The drawing is a schematic diagram of a system for switching content displayed by a projector in accordance with a preferred embodiment of the present invention.

### DETAILED DESCRIPTION OF THE EMBODIMENT

A system for switching among available media sources for content displayed by a projector in accordance with a preferred embodiment of the present invention is described herein. Referring to the drawing, the system includes a plurality of computers 10 used as display content providers respectively, a connecting device 20, and a display device like a projector 30.

In this embodiment Bluetooth is used as an example. The computers 10 are each equipped with a Bluetooth device 110. Each Bluetooth device 110 is a wireless receiving module used to transmit data. Each Bluetooth device 110 has a built-in antenna. Each Bluetooth device 110 can send contents of the corresponding computer 10 to an input end of the connecting device 20 by using the Bluetooth protocol. The connecting device 20 includes a receiving device 22, and a multiplexer 24. The connecting device 20 may be a built-in component of the projector or a component located outside of the projector 30. The input end of the connecting device 20 is at the same time to be used as an input end of the receiving device 22, and an output end of the connecting device 20 is a signal output end D of the multiplexer 24.

Each Bluetooth device 110 operates on a frequency of 2.4 GHZ. The receiving device 22 receives wireless signals that are sent by the computers 10 via its basis frequency conversion function, and then converts the signals to a form that is accepted by a digital signal processing chip in the projector 30. The multiplexer 24 is radio controlled by an infrared remote controller 26.

At this time the Bluetooth protocol allows the connecting device 20 to support up to eight devices, that is, each connecting point may connect one master device, and seven slave devices to operate at the same time. The slave devices can share the contents of a file. The Bluetooth technology supports Peer-to-Peer (P2P), or Peer-to-Many wireless connecting. All of these cooperatively form a Bluetooth wireless net referred to as a piconet. At any given time there is one master device allowed in the piconet, and other devices are slaves, the master device uses its clock and jump sequence to synchronize the various slave devices.

Before building the piconet, the various devices are in a standby state, the master device presides over the initialization of the piconet. The master device forms connections between devices by page message or inquiry message. In the piconet the slave devices are in one of two states; active or dormant. Only one slave device at a time may be active and supply data to the master device. The remaining slave devices are dormant and can keep synchronization with the other devices, but they can't transmit data. Each Bluetooth device 110 has a 48-bit BD-ADDR (Bluetooth device-address). In building the piconet, an accredited group is formed using the BD-ADDR so that other devices not authorized cannot participate in the piconet to ensure security.

In the system for switching content displayed by a projector, the projector 30 is the master device, it provides synchronization clock signals and jump sequence, the computers 10 are the slave devices. Binary codes C0, C1, and C2 are used for a coding of the multiplexer 24, and they can form eight passage addresses. For example, C0, C1, C2=000 indicates that the contents of the computer whose User ID number is 0 will be projected, and C0, C1, C2=101 indicates that the contents of the computer whose User ID number is 5 will be projected, and so on. So the function of the multiplexer 24 is to receive content from a selected slave computer 10 of the piconet, and output the content to the input end of the projector 30, then the projector 30 projects the content to a screen or other suitable surface.

At start up of the projector 30, its wireless function is in an unconnected state, and the projector 30 waits for wireless connection to the computers 10 that have built-in Bluetooth devices 110. The projector 30 is configured with an unchangeable, unique projector ID when it leaves the factory for use in wireless networking, and the user cannot change it in the future. When the connecting device 20 is started, an enable signal of the multiplexer 24 is turned on, and the computers 10 within the wireless receiving area each receive a unique user ID via the Bluetooth protocol.

The slave computers 10 automatically search all the available projectors in the wireless net, and list the projector IDs for the users to choose from. When the ID of the projector 30 is chosen, the projector 30 is connected into the wireless net. Then the projector 30 can complete self-configuration in a few seconds. Any connected slave computer 10 may be selected and content on that computer prepared before hand is wirelessly transmitted for projection by the projector 30. The contents of the chosen computer 10 are converted to basis frequency signals via a wireless frequency modulation function of the receiving device 22. Then the basis frequency signals are separately stored in a certain passage of the multiplexer 24 according to various user IDs of the computers 10. Ultimately, the output end of the multiplexer 24 outputs the contents to the antenna of the projector 30. The user can command one of the computers 10 to work by the remote controller 26 due to varying User IDs of the computers 10. The content of the selected computer 10 is received wirelessly by the projector 30 for projection.

According to the embodiment of the present invention, different screen contents of the various computers 10 are switched quickly via the multiplexer 24 and the controller 26. And the whole projection processing is completed in a wireless way.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

We claim:

1. A system for switching among available media source for content displayed by a projector, comprising:
a plurality of computers each with a wireless device for wireless communication;
a projector for displaying content source from each of the computers; and
a connecting device together with the wireless device wirelessly transmitting signals of the content source from each of the computers to the projector according to wireless protocols.

2. The system as claimed in claim 1, wherein the computers communicate with the connecting device and the projector via Bluetooth protocols.

3. The system as claimed in claim 2, wherein the connecting device comprises a wireless receiving means for connecting with the computers wirelessly, and further comprises a multiplexer for selecting one of the computers to communicate with the receiving means via the Bluetooth protocols.

4. The system as claimed in claim 3, wherein the content source from each of the computers is converted to a form that is acceptable by the projector via the receiving means, and then the content source is switched by the multiplexer.

5. The system as claimed in claim 2, wherein the wireless device is a Bluetooth device.

6. The system as claimed in claim 2, wherein the connecting device is a built-in component of the projector.

7. The system as claimed in claim 2, wherein the connecting device is a component located outside of the projector.

8. The system as claimed in claim 2, wherein an input end of the connecting device receives wireless signals from the computers, and an output end of the connecting device connects with an input end of the projector.

9. A method for providing display content to a display device, comprising the steps of:
establishing a wireless signal-communicable net including a display device and a plurality of display content providers therein so as to allow said display device capable of being signal communicable with said plurality of display content providers respectively;
identifying each of said plurality of display content providers via a user identification (ID); and
retrieving display content from a selective one of said plurality of display content providers to said display device for display based on said identifiable user ID.

10. The method as claimed in claim 9, wherein said display device comprises a connecting device with a receiving means and a multiplexer therein, said receiving means is used for said display device to signal-communicate with said each of said plurality of display content providers wirelessly, and said multiplexer is used for choosing said selective one of said plurality of display content providers to signal-communicate with said display device by means of said user ID.

11. The method as claimed in claim 9, wherein said wireless signal communicable net is compatible with Bluetooth protocols.

12. The method as claimed in claim 9, wherein said selective one of said plurality of display content providers is an exclusive one out of said plurality of display content providers to provide said display content to said display device at any point of time.

13. The method as claimed in claim 9, further comprising the step of switching to another selective one of said plurality of display content providers based on another identifiable user ID.

14. A method for switching among available media sources for content displayed by a projector, comprising the steps of:
establishing a wireless net between a plurality of computes and a projector, so as to flexibly switch content from each of the computers to the projector in said wireless net;
establishing communication between said projector and one of the computers via a connecting device; and
switching from each of said one of the computers to another one of the computers in said wireless net by using said connecting device.

15. The method as claimed in claim 14, wherein the computers each have a built-in Bluetooth device.

16. The method as claimed in claim 15, wherein the connecting device comprises receiving means and a multiplexer, said projector is communicable with said one of the computers via Bluetooth protocols.

17. The method as claimed in claim 16, wherein the content from said one of the computers is converted to a form that is acceptable by the projector via the receiving means, and then the receipt of content from one of the computers is switched to receipt from another one of the computers by the multiplexer, and wherein the multiplexer is controlled by a remote controller.
